(19) United States
(12) Patent Application Publication
(10) Pub. No.: US 2008/0232093 A1
(43) Pub. Date: Sep. 25, 2008

(54) Seamless lighting assembly

(75) Inventor: Steven Kim, Palisades Park, NJ (US)

Correspondence Address: SEYFARTH SHAW, LLP, 815 CONNECTICUT AVENUE, N.W., SUITE 500, WASHINGTON, DC, 20006, US

(73) Assignee: LED Folio Corporation, Palisades Park, NJ (US)

(21) Appl. No.: 12/076,743

(22) Filed: Mar. 21, 2008

Related U.S. Application Data
(60) Provisional application No. 60/907,154, filed on Mar. 22, 2007.

(51) Int. Cl. F21S 8/00

(52) U.S. Cl. 362/147

(57) ABSTRACT

A light-emitting diode lighting assembly, including a plurality of light-emitting diode lighting panels with light-emitting diodes positioned on at least one edge of the light-emitting diode lighting panels, a plurality of prism plates for refracting light emitted by the light-emitting diodes, wherein each of the plurality of prism plates is respectively positioned above one of the light-emitting diode panels, and a top plate covering the plurality of prism plates such that the light emitting diode lighting assembly appears seamless.

This invention claims the benefit of the Provisional Patent Application 60/907,154 filed with the U.S. Patent and Trademark Office on Mar. 22, 2007, which is hereby incorporated by reference in its entirety.

### BACKGROUND OF THE INVENTION

The present invention relates to lighting, and more particularly, to light-emitting diode lighting assembly. Although the present invention is suitable for a wide scope of applications, it is particularly suitable for providing a seamless light-emitting diode lighting assembly for either drop-ceilings, drywall/plaster ceilings or walls.

In general, ceiling lighting fixtures are either based on incandescent or fluorescent bulbs. Such lighting fixtures can be bulky and are generally not energy efficient. While bulbs usually provide adequate luminous intensity for the lighting of interior spaces, bulbs can often cause problems. For example, incandescent bulbs are brittle and need frequent replacement. Fluorescent bulbs are more robust and energy efficient, but often emit light that is less pleasing and cause environmental or safety problems when broken. In contrast, light emitting diode based lighting fixtures are long-lasting, safe and, can provide pleasant white light.

Light emitting diode lighting fixtures can be installed directly on drywall/plaster ceilings by direct attachment to either roof joists or floor joists. Alternatively, light emitting diode fixtures can be installed in drop-ceilings. In either case, light emitting diode lighting fixtures are more efficient than either the incandescent bulbs or the fluorescent bulbs.

Although the lighting efficiency of a light-emitting diode lighting fixture is high, heat is still generated by the light-emitting diodes of a light-emitting diode lighting fixture. Removal or dissipation of such heat away from the light-emitting diodes is a determining factor in both the efficiency and the overall durability of the light-emitting diodes. Accordingly, heat dissipation for the light emitting diodes is a design element of an LED lighting fixture. However, the positioning of the light-emitting diodes for heat dissipation in an LED lighting fixture may not be conducive to efficient use of the light emanating from the light-emitting diodes. Further, the addition of heatsink structures for efficient thermal dissipation may detract from the aesthetics of the fixture and impede implementation of the fixture.

The two major design difficulties associated with light emitting diode based ceiling lighting fixtures involve dealing with heat dissipation from the light emitting diodes and increasing brightness/efficiency. These problems are inversely related. In other words, increasing light emitting diode density in the device increases brightness, but also increases problems associated with light emitting diode overheating.

### SUMMARY OF THE INVENTION

Accordingly, the present invention is directed to a light-emitting diode lighting assembly that substantially obviates one or more of the problems due to limitations and disadvantages of the related art.

An object of the present invention is to provide a light-emitting diode lighting assembly with a seamless appearance.

Another object of the present invention is to provide a light-emitting diode lighting assembly with increased efficiency.

Another object of the present invention is to provide a light-emitting diode lighting assembly with improved thermal dissipation capability.

Another object of the present invention is to provide a light-emitting diode lighting assembly configured to reside in ceiling-grids.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the invention, as embodied and broadly described, the light-emitting diode lighting assembly includes a light-emitting diode lighting assembly, including a plurality of light-emitting diode lighting panels with light-emitting diodes positioned on at least one edge of the light-emitting diode lighting panels, a plurality of prism plates for refracting light emitted by the light-emitting diodes, wherein each of the plurality of prism plates is respectively positioned above one of the light-emitting diode panels, and a top plate covering the plurality of prism plates such that the light emitting diode lighting assembly appears seamless.

In another aspect, the light-emitting diode lighting assembly includes a light-emitting diode lighting assembly, including a plurality of light-emitting diode lighting panels with light-emitting diodes positioned on at least one edge of the light-emitting diode lighting panels, a plurality of prism plates for refracting light emitted by the light-emitting diodes, wherein each of the plurality of prism plates is respectively positioned above one of the light-emitting diode panels, at least one gap between the plurality of light-emitting diode lighting panels and the plurality of prism plates for directing heat generated by the light-emitting diodes away from the light-emitting diode lighting panels, and a top plate covering the plurality of prism plates such that the light emitting diode lighting assembly appears seamless.

In yet another aspect, the light-emitting diode lighting assembly includes a light-emitting diode lighting assembly, including a plurality of light-emitting diode lighting panels with light-emitting diodes positioned on at least one edge of the light-emitting diode lighting panels, a plurality of prism plates for refracting light emitted by the light-emitting diodes, wherein each of the plurality of prism plates is respectively positioned above one of the light-emitting diode panels and each of the plurality of prism plates has a front side, and a backside, the backside of the plurality of prism plates having a periphery and being covered with beveled rows for refracting light and the periphery of the backside being beveled for refracting light, at least one gap between one of the plurality of light-emitting diode lighting panels and a beveled backside of one of the plurality of prism plates for directing heat generated by the light-emitting diodes away from the light-emitting diode lighting panels, and a top plate covering the plurality of prism plates such that the light emitting diode lighting assembly appears seamless.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A is a disassembled view of a light emitting diode panel;

FIG. 1B is a close-up perspective view of the light emitting diodes of the light emitting diode panel of FIG. 1A;

FIG. 1C is an assembled view of the light emitting diode panel of FIGS. 1A and 1B;

FIG. 2 is an assembly of light emitting diode panels that replaces a drop-ceiling tile;

FIG. 3A is a side view of another assembly of light emitting diode panels;

FIG. 3B is a close-up side view of the assembly in FIG. 3A;

FIG. 4A is a close-up, cross-sectional view of the prism plate of embodiments of the invention;

FIG. 4B is a close-up, perspective view of the top of a micro-lens patterned layer of the prism plate of FIG. 4A;

FIG. 4C is a close-up, cross-sectional view of the micro-bead patterned layer of the prism plate of FIG. 4A;

FIG. 5A is a another side view of the assembly of light emitting diode panels of FIG. 3A; and

FIG. 5B is a bottom view of the assembly of FIG. 5A.

### DETAILED DESCRIPTION OF THE PREFERRED EMBODIMENTS

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

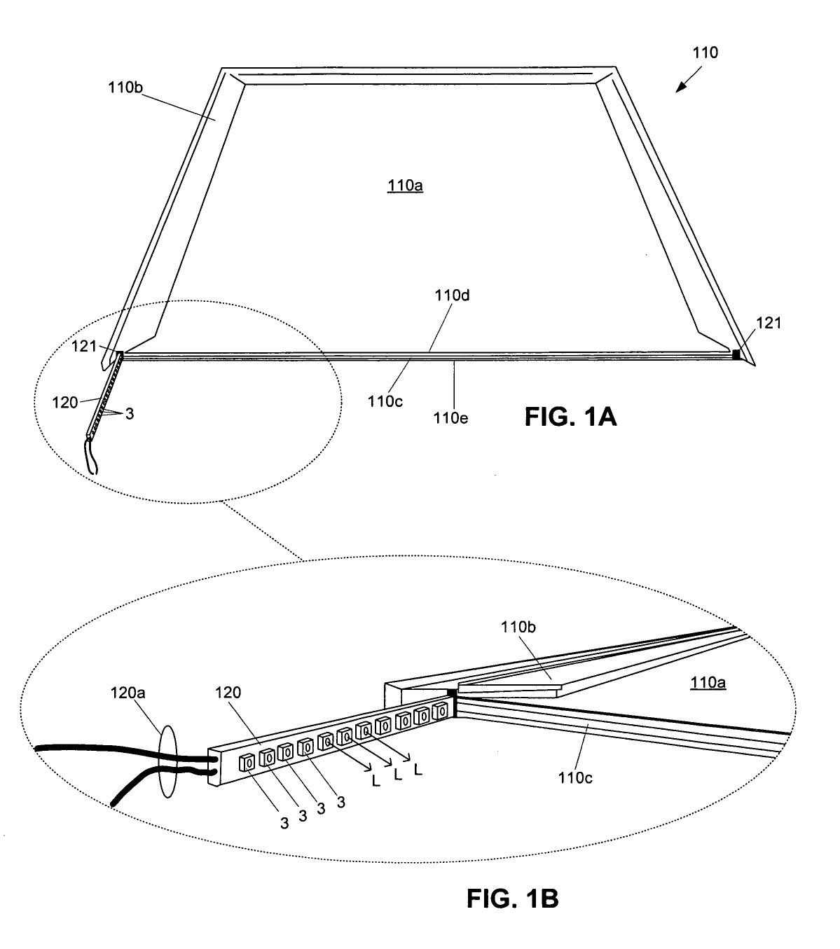

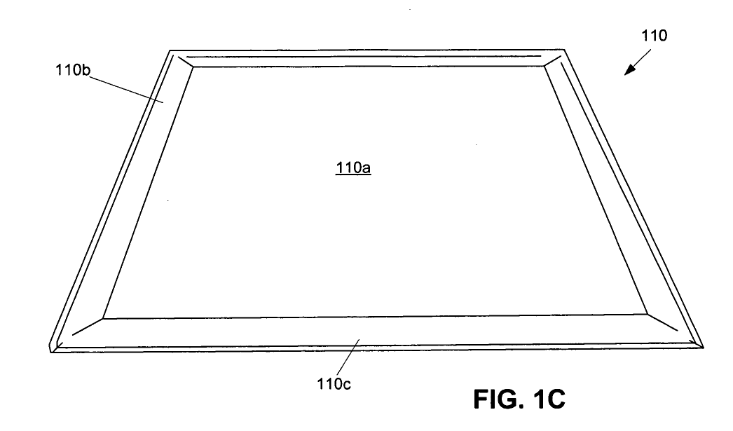

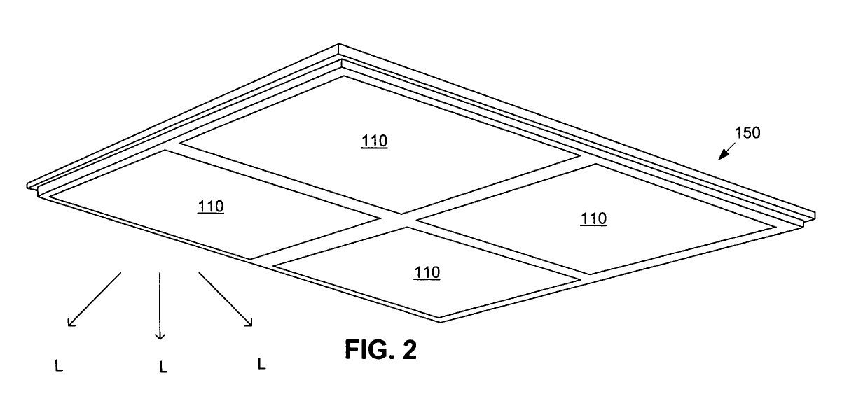

FIG. 1A is a disassembled view of a light emitting diode panel and FIG. 1B is a close-up perspective view of the light emitting diodes of the light emitting diode panel in FIG. 1A. FIG. 1C is an assembled view of the light emitting diode panel of FIGS. 1A and 1B. As shown in FIG. 1A, each light emitting diode panel 110 a middle section 110a. The periphery of the middle section 110a is surrounded by an edge 110b that contains strips 120 of light emitting diodes 3, as shown in both FIGS. 1A and 1B. The edge 100b can be composed of one or a combination of materials, including a metal. The edge 110b can have cavities at the edges of the light emitting diode panel 110, as shown in FIGS. 2A and 2B, and strips 120 are located in the cavities 121. Alternatively, the edge 110b can be open and contain a groove, lever or other fastener to hold the strips 120 in place. Although not shown in FIGS. 1A and 1B, the edge 110b accommodates multiple strips 120 of light emitting diodes 3 around the light emitting diode panel 110 such that there are light emitting diodes 3 completely surrounding the middle section 110a of the light emitting diode panel 110. The edge 110b can accommodate two strips 120 of light emitting diodes 3, as shown in FIGS. 1A and 1B, or three or more strips 120.

As shown in FIGS. 1A and 1B, the light emitting diodes 3 mounted to the strip 120 can be top emitting diodes with a flat surfaces. Alternatively, the light emitting diodes 3 mounted to the strip 120 can have concave, convex or other rounded surfaces. The light emitting diodes 3 can emit white light or, alternative, can emit light of a color other than white. There can be multiple types of light emitting diodes 3 on the strip 120 so that multiple colors of light emitted. Each light emitting diode 3 can be separately controlled so as to control the overall color of the light emitted and to set its mood. As shown in FIG. 1B, the light emitting diodes 3 of the strip 120 face the middle section 110a of the light emitting diode panel so that that the light emitted L is directed toward the light guide panel 110c. Alternatively, the light emitting diodes 3 may face in a direction that is other than toward the light guide panel 110c and the light L emitted by the light emitting diodes 3 can be directed by a series of mirrors, light guide strips, prisms or panels (not shown).

The light guide panel 110c is in the inside of the middle section 110 of the light emitting diode panel 110 and directs the light L emitted by the light emitting diodes 3 as needed. The light guide panel 110c can be composed of one or a combination of materials including, plastics and glasses. The light guide panel 110c can be semi-transparent, as shown in FIG. 1B, or transparent with diffusion elements dispersed throughout the light guide panel 110c. The light guide panel 110c can have a diffusion film 110d on the top of the light guide panel 110c and a reflector 110e, as shown in FIG. 1A. The diffusion film 110d and the reflector 110e can respectfully diffuse and direct the light emitted by the light emitting diodes 3.

The strip 120 can be flexible for ease of insertion. The strip 120 can be composed of one of or a combination of a flexible plastic, a metalized plastic or other flexible material. Alternatively, the strip 120 can be composed of an inflexible material such as a metal or combination of metal and plastic. The strip 120 can transfer heat generated by the light emitting diodes 3 to the metal sides of the assembly 110, such as the edge 110b. The strip 120 contains wiring 120a for supplying power to the light emitting diodes 3, as shown in FIG. 1B.

FIG. 2 is an assembly of light emitting diode panels that replaces a drop-ceiling tile. As shown in FIG. 2, each assembly 150 includes separate light emitting diode panels 110. The assembly 150 is sized to be the same size as a drop-ceiling tile (not shown), so the assembly 150 can be simply inserted in place of the drop-ceiling tile (not shown). There can be four light emitting diode panels 110, as depicted in FIG. 2, or there can be two, three, five or more light emitting diode panels in an assembly 150. Alternatively, the assembly 150 can be sized to be the same size as several drop-ceiling tiles (not shown). The assembly 150 can be mounted in a drop-ceiling alongside conventional drop-ceiling tiles (not shown) to create a ceiling structure that incorporates the light source directly into the drop-ceiling. Alternatively, the drop-ceiling can be composed entirely of assembly tiles 150 to create a planar luminescent ceiling.

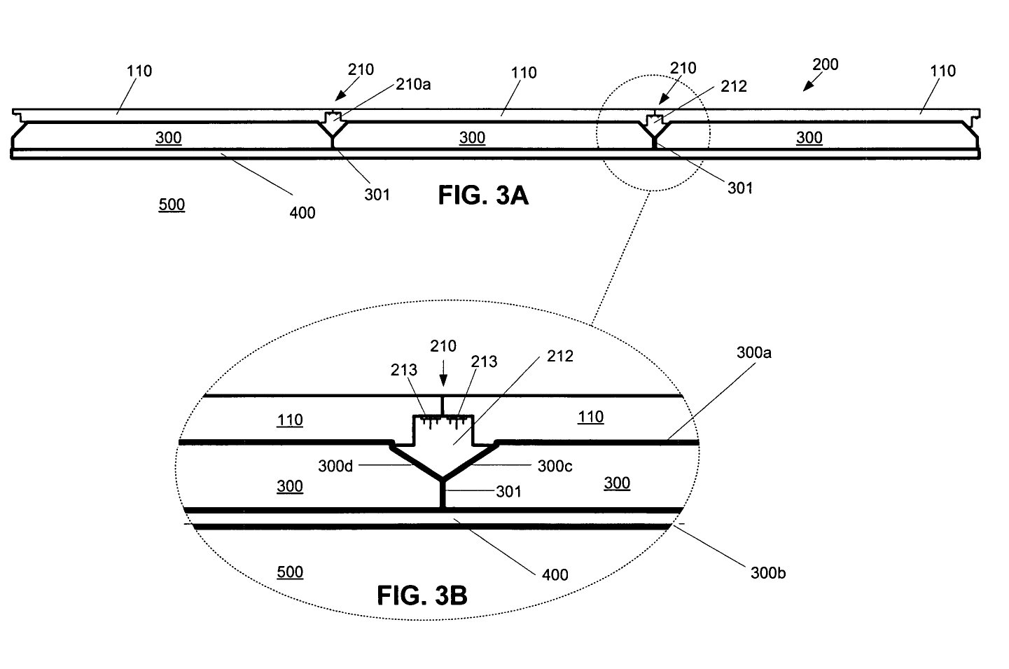

FIG. 3A is a side view of another assembly of light emitting diode panels and FIG. 3B is a close-up side view of the assembly in FIG. 3A. The assembly 200 of FIGS. 3A and 3B is made to cover a surface, as opposed to the assembly 150 in FIG. 2 that is meant to replace a single drop-ceiling tile. Although three light guide panels 110 are shown in FIG. 3A, the assembly can include two, four or more light guide panels 110. As shown in FIG. 3A, the assembly 200 includes several light guide panels 110 in contact with each other at contact lines 210. The contact lines 210 are where the light guide panels 110 abut each other. The light guide panels 110 can be interconnected so that power is supplied to the light emitting diodes 3 (FIGS. 2A and 2B). Beneath the contact lines 210 are passages 212 that can serve as channels for dissipating heat produced by the light emitting diodes 3 (FIGS. 2A and 2B) during operation of the assembly 150. The passages 212 can be empty, as shown in FIGS. 3A and 3B, or be filled in with a number of devices (not shown) that serve to dissipate heat such as fans, air circulation devices, heat sinks, heat conduction lines or other heat dissipation structures such as heat fins. The passages 212 can also contain various wiring (not shown) or electrical connections. The passages 212 can be interconnected to form a network of passage ways for heat dissipation or form separate channels, as shown in FIGS. 3A and 3B. The passages 212 can have additional vents and holes (not shown) for increasing ventilation and air flow.

As shown in FIGS. 3A and 3B, each light guide panel 110 is in contact with a prism plate 300. The prism plate 300 and the light guide panel 110 can be in continuous contact along the top 300a of the prism plate 300, as shown in FIGS. 3A and 3B. Alternatively, there can be a layer (not shown) between the prism plate 300 and the light guide panel 110. The layer (not shown) can include an adhesive for attaching the prism plate 300 to the light guide panel 110. As also shown in FIGS. 3A and 3B, a top plate 400 can be placed over each prism plate 300. The prism plate 300 and the top plate 400 can be in direct contact, as shown in FIGS. 3A and 3B. Alternatively, there can be a layer (not shown) between the prism plate 300 and the top plate 400 to bond the prism plate 300 and the top plate 400 together.

The top plate 400 covers the seams 301 between each of the prism plates 300, as shown in FIG. 3A. The top plate 400 creates a seamless presentation to the space 500 to be illuminated by the assembly, as shown in FIGS. 3A and 3B. The top plate 400 can contact the bottom 300b of the prism plate 300 continuously, as shown in FIG. 3B. The top plate 400 is generally a light diffusion material. Alternatively, the top plate 400 can be semi-transparent. The top plate 400 can be composed of one or a combination of transparent or semi-transparent materials, including glass or plastic. The top plate 400 can have edge beveling (not shown) or the top plate 400 can have other patterning at the edges to create light refraction. The top plate 400 can provide a completely seamless cover to the assembly, as shown in FIG. 3A, or have seams that are not directly over and in parallel with the contact lines 210.

As shown in FIG. 3B, the light guide panels 110 can have heat sinks 213 that dispersed the heat created during the operation of the light-emitting diodes (not shown). The heat sinks 213 can be finned, as shown in FIG. 3B. The heat sinks 213 can have heat conduction sections (not shown) for conducting heat away from the light guide panels 110. They can be placed in the passages 212 of the assembly 200 for conducting the heat into the passages 212. Alternatively, they can be placed on the exterior of the light guide panels 110.

The prism plate 300 has beveled edges 300c and 300d, as shown in FIG. 3B, so as to refract light emitted by the light guide panel 110. The prism plate 300 can have edge beveling, as shown in FIGS. 3A and 3B, or other patterning at the edges to create light refraction. The prism plate 310 can be of one of or a combination of transparent or semi-transparent materials, such as glass or plastic. The prism plate 310 can contain multiple layers with differing mechanical, chemical and/or optical properties. The prism plate 310 can also contain additional reflectors (not shown) positioned around the prism plate 310 so as to reflect the light provided to the prism plate 310 by the light guide panel 110. The top plate 400 can be a monolithic, single layer, as shown in FIG. 3A, or multiple layers. The top plate 400 can have homogeneous optical properties, or continuously varying optical properties. Alternatively, the top plate 400 can have an anti-reflective coating (not shown) or other optical coatings (not shown).

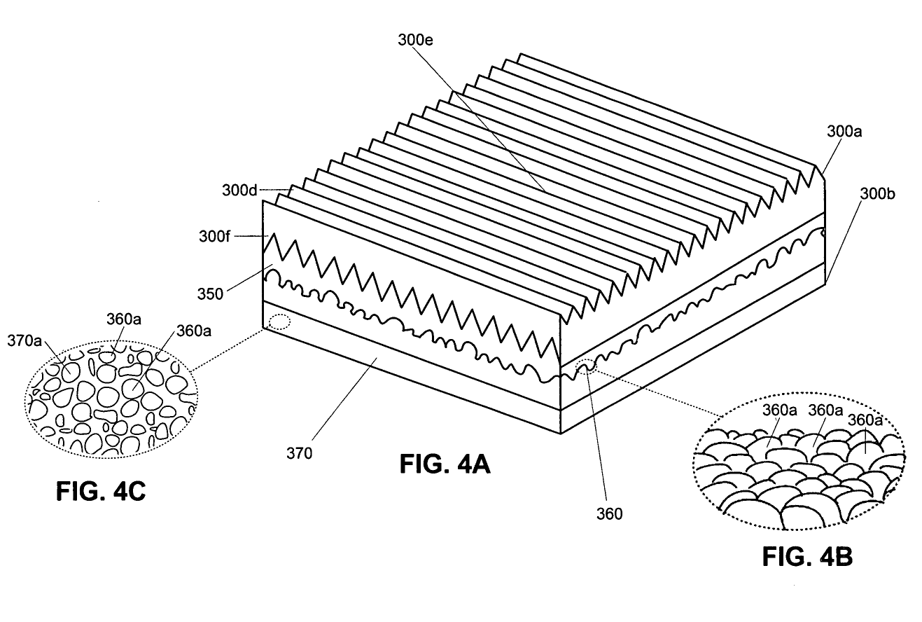

FIG. 4A is a close-up, cross-sectional view of the prism plate of embodiments of the invention. As shown in FIG. 4A, the prism plate 300 can have a prism pattern 300d that covers the entire area 300e of the top 300a. Alternatively, the prism plate 300 can be flat or have a different pattern covering the entire area 300e of the top 300a. The prism pattern 300d can have a pyramid shape, as shown in FIG. 4A, or the prism pattern 300d can have a number of other shapes including a more rounded shape, a cylindrical shape or rounded bump shape. The prism plate 300 can have a second prism pattern 300f, as shown in FIG. 4A. As shown in FIG. 4A, the second prism pattern 300f is perpendicular to the prism pattern 300d. Alternatively, the second prism pattern 300f that is parallel to or makes an oblique angle (not shown) with the prism pattern 300d of the top 300a of the prism plate 300. The second prism pattern 300f can have a pyramid shape, as shown in FIG. 4A, or the prism pattern 300f can have a number of other shapes including a more rounded shape, a cylindrical shape or rounded bump shape. Alternatively, there can be only one prism pattern, either 300d or 300f. The two prism patterns 300d and 300f are composed of one of or a combination of transparent or semi-transparent materials, such as glass or plastic.

As shown in FIG. 4A, the prism plate 300 can contain additional layers, such as a low refraction 350 and the micro-lens pattern 360. FIG. 4B is a close-up, perspective view of the top of a micro-lens patterned layer of the prism plate of FIG. 4A. The low refraction layer 350 separates the prism patterns 300d and 300f from the micro-lens pattern 360 and the micro-bead layer 370, as shown in FIG. 4A. The low refraction layer 350 can channel light L produced by the light emitting diodes 2 (FIG. 2B) in the light guide panel 110 to the prism layer 300. Generally, the low refraction layer 350 is as transparent as possible. The low refraction layer 350 can be composed of one or a combination of materials including glass, plastic or other transparent or semi-transparent materials.

The micro-lens pattern 360 includes a series of convex lenses 360a, as shown in FIG. 4B, that focus the light exiting the prism pattern 300f. Various optical elements (not shown) can be embedded in the micro-lens pattern 360, such as prisms light guides or other channels. The convex lenses 360a can be formed by one of bubbling, etching and micro fabrication. The micro-lens pattern 360 can be formed separately from the prism patterns 300d and 300f and subsequently attached to the prism patterns 300d and 300f, or formed at the same time and on the same monolithic piece of material as the prism patterns 300d and 300f. The micro-lens pattern 360 can be patterned on a number of size scales, including the macro, micro and nanoscopic size scales. The convex lenses 360a can all be formed of the same material, or formed from different materials.

FIG. 4C is a close-up, cross-sectional view of the micro-bead patterned layer of the prism plate of FIG. 4A. The micro-bead layer 370 includes a small transparent or semi-transparent beads 370a, as shown in FIG. 4C, that focus or direct the light exiting the prism pattern 300f. The beads 370a can be formed by bubbling, etching and micro fabrication. The beads 370a can be formed separately from low refraction layer 350 and subsequently attached to low refraction layer 350, or formed at the same time and on the same monolithic piece of material as the low refraction layer 350. The beads 370a can be formed in a number of size scales, including macro, micro and nanoscopic size scales. The beads 370a can all be formed of the same material, or formed from different materials. The beads 370a can be sintered, partially sintered, or compressed. Alternatively, the beads 370a can be glued together. Filler material (not shown) in between the beads 370a, or there can be voids between the beads 370a. In addition, various other optical elements (not shown) can be embedded in the micro-bead layer 370.

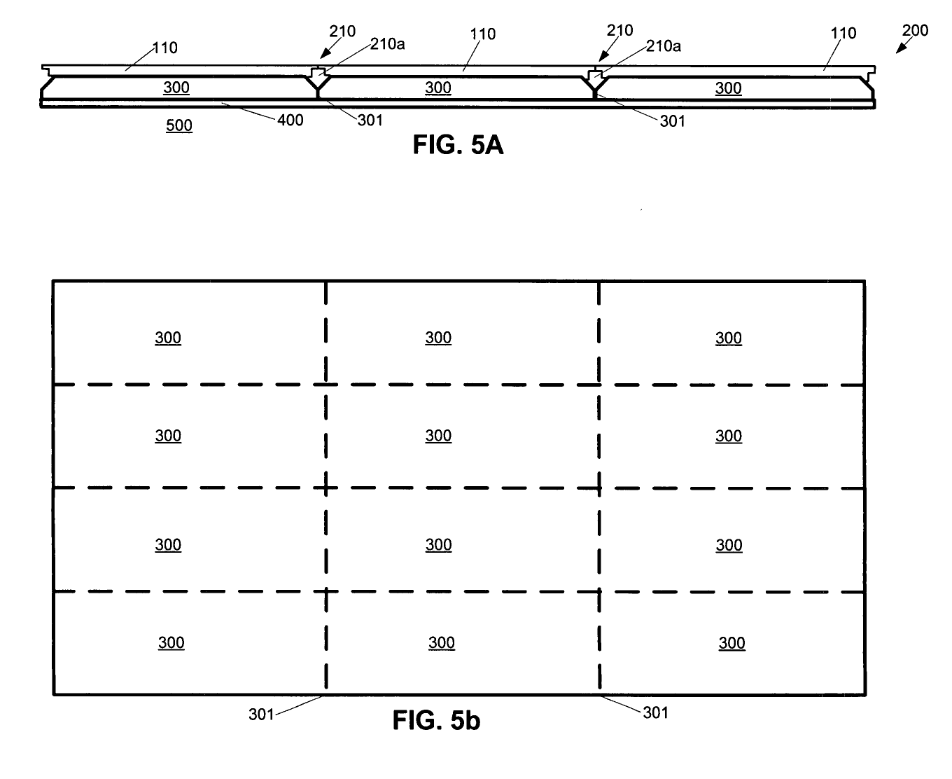

FIG. 5A is a another side view of the assembly of light emitting diode panels of FIG. 3A. and FIG. 5B is a bottom view of the assembly of FIG. 5A. The view in FIG. 5B is looking through the top layer 400 (FIG. 5A) at the bottom 300b (FIG. 4A) of the prism layer 300. As can be seen from FIG. 5B, if the top layer 400 makes the seams 301 between each of the prism plates 300 completely transparent when viewed from the space 500 to be illuminated (FIG. 3A). More specifically, the top layer 400 is slightly opaque such that the seams 301 between each of the prism plates 300 become invisible when viewed from the space 500 to be illuminated (FIG. 3A). Thus, the entire lighting assembly 200 becomes an apparently seamless display. This creates a “wall of light” effect that is pleasing to the observer. On the other hand, each of the light guide panels can be different colors but yet the assembly 200 still appears seamless.

It will be apparent to those skilled in the art that various modifications and variations can be made to low-clearance lighting of the present invention without departing from the spirit or scope of the invention. Thus, it is intended that the present invention covers the modifications and variations of this invention provided they come within the scope of the appended claims and their equivalents.

What is claimed is:

1. A light-emitting diode lighting assembly, comprising:
a plurality of light-emitting diode lighting panels with light-emitting diodes positioned on at least one edge of the light-emitting diode lighting panels;
a plurality of prism plates for refracting light emitted by the light-emitting diodes, wherein each of the plurality of prism plates is respectively positioned above one of the light-emitting diode panels; and
a top plate covering the plurality of prism plates such that the light emitting diode lighting assembly appears seamless.

2. The light-emitting diode lighting assembly of claim 1, wherein the light-emitting diodes are on a strip.

3. The light-emitting diode lighting assembly of claim 1, wherein the top plate is in direct contact with each of the light-emitting diode lighting panels.

4. The light-emitting diode lighting assembly of claim 1, wherein the assembly includes frames at the peripheries of the light-emitting diode lighting panels.

5. The light-emitting diode lighting assembly of claim 4, wherein the light-emitting diodes are within the frames.

6. The light-emitting diode lighting assembly of claim 1, wherein each of the plurality of prism plates has a front side and a backside having a periphery and the periphery of the backside is beveled so as to refract light and provide even illumination to the top plate.

7. The light-emitting diode lighting assembly of claim 1, wherein at least one gap is located between one of the plurality of light-emitting diode lighting panels and one of the plurality of prism plates.

8. The light-emitting diode lighting assembly of claim 7, wherein the at least one gap forms a passage to the exterior of the assembly for directing heat generated by the light-emitting diodes away from the light-emitting diode lighting panels.

9. The light-emitting diode lighting assembly of claim 1, further comprising heat dispersers between the plurality of light-emitting diode lighting panels and the plurality of prism plates.

10. A light-emitting diode lighting assembly, comprising:
a plurality of light-emitting diode lighting panels with light-emitting diodes positioned on at least one edge of the light-emitting diode lighting panels;
a plurality of prism plates for refracting light emitted by the light-emitting diodes, wherein each of the plurality of prism plates is respectively positioned above one of the light-emitting diode panels;
at least one gap between the plurality of light-emitting diode lighting panels and the plurality of prism plates for directing heat generated by the light-emitting diodes away from the light-emitting diode lighting panels; and
a top plate covering the plurality of prism plates such that the light emitting diode lighting assembly appears seamless.

11. The light-emitting diode lighting assembly of claim 10, wherein the light-emitting diodes are on a strip.

12. The light-emitting diode lighting assembly of claim 10, wherein the top plate is in direct contact with each of the light-emitting diode lighting panels.

13. The light-emitting diode lighting assembly of claim 10, wherein the assembly includes frames at the peripheries of the light-emitting diode lighting panels.

14. The light-emitting diode lighting assembly of claim 10, wherein each of the plurality of prism plates has a front side and a backside having a periphery and the periphery of the backside is beveled so as to refract light and provide even illumination to the top plate.

15. The light-emitting diode lighting assembly of claim 10, wherein the light-emitting diodes are within the frames.

16. The light-emitting diode lighting assembly of claim 10, further comprising heat dispersers between the plurality of light-emitting diode lighting panels and the plurality of prism plates.

17. A light-emitting diode lighting assembly, comprising:
a plurality of light-emitting diode lighting panels with light-emitting diodes positioned on at least one edge of the light-emitting diode lighting panels;
a plurality of prism plates for refracting light emitted by the light-emitting diodes, wherein each of the plurality of prism plates is respectively positioned above one of the light-emitting diode panels and each of the plurality of prism plates has a front side, and a backside;
the backside of the plurality of prism plates having a periphery and being covered with beveled rows for refracting light and the periphery of the backside being beveled for refracting light;
at least one gap between one of the plurality of light-emitting diode lighting panels and a beveled backside of one of the plurality of prism plates for directing heat generated by the light-emitting diodes away from the light-emitting diode lighting panels; and
a top plate covering the plurality of prism plates such that the light emitting diode lighting assembly appears seamless.

18. The light-emitting diode lighting assembly of claim 17, wherein the light-emitting diodes are on a strip.

19. The light-emitting diode lighting assembly of claim 17, wherein the assembly includes frames at the peripheries of the light-emitting diode lighting panels.

20. The light-emitting diode lighting assembly of claim 19, wherein the light-emitting diodes are within the frames.
